(19) United States
(12) Patent Application Publication
(10) Pub. No.: US 2018/0194455 A1
(43) Pub. Date: Jul. 12, 2018

(54) DRONE, MOBILE TERMINAL, AND CONTROL METHOD FOR DRONE AND MOBILE TERMINAL

(71) Applicant: LG ELECTRONICS INC., Seoul (KR)

(72) Inventors: Chansul PARK, Seoul (KR); Sunho YANG, Seoul (KR); Byeongkil AHN, Seoul (KR); Woosok CHANG, Seoul (KR)

(73) Assignee: LG ELECTRONICS INC., Seoul (KR)

(21) Appl. No.: 15/742,325

(22) PCT Filed: Jul. 8, 2015
(86) PCT No.: PCT/KR2015/007039

§ 371 Date: Jan. 5, 2018

(30) Foreign Application Priority Data
Jul. 6, 2015 (KR) 10-2015-0095997

(51) Int. Cl. B64C 19/02; B64C 39/02; G05D 1/00; G06K 9/00

(52) U.S. Cl. CPC B64C 19/02; B64C 39/024; G05D 1/0016; B64C 2201/127; G06K 9/00288; B64C 2201/146; B64C 2201/123; G05D 1/0038

(57) ABSTRACT

The present invention relates to a drone capable of wirelessly communicating with a mobile terminal, the mobile terminal, and a control method for the drone and the mobile terminal. The drone according to one embodiment of the present invention comprises: a communication unit for wirelessly communicating with a first mobile terminal; and a control unit for performing a function corresponding to a control signal received from the first mobile terminal, on the basis of the control signal, wherein the control unit transmits a control request signal to a second mobile terminal other than the first mobile terminal on the basis of the strength of a connected signal and/or the reception of a preset control signal in a state of being connected to the first mobile terminal so as to wirelessly communicate therewith.

### TECHNICAL FIELD

The present invention relates to an unmanned aerial vehicle capable of performing wireless communication with a mobile terminal, a mobile terminal, and a control method thereof.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As the mobile terminal becomes multifunctional, it is implemented as a multimedia player having complicated functions such as capturing images or videos, playing music or videos, playing games, and receiving broadcastings.

Various attempts have been made to implement complicated functions in such a multimedia device by means of hardware or software.

In recent years, various technologies have been developed for controlling the driving of external devices connected to perform wireless communication with a mobile terminal using the mobile terminal. For example, in recent years, technologies for controlling an unmanned aerial vehicle using a mobile terminal have been actively developed.

Meanwhile, when an unmanned aerial vehicle is controlled by a mobile terminal, various unexpected situations may occur. In this case, the unmanned aerial vehicle may not be controlled by the mobile terminal during flight.

### DISCLOSURE OF THE INVENTION

An aspect of the present invention is to provide an unmanned aerial vehicle which may be controlled by a mobile terminal in an optimized manner, a mobile terminal and a control method thereof.

Another aspect of the present invention is to provide an unmanned aerial vehicle, a mobile terminal, and a control method thereof that may maintain control and flight of an unmanned airplane even though a mobile terminal controlling the unmanned aerial vehicle enters an uncontrollable state.

An exemplary embodiment of the present invention provides an unmanned aerial vehicle (UAV) including: a communication unit performing wireless communication with a first mobile terminal; and a controller performing a function corresponding to a control signal received from the first mobile terminal, wherein in a state that the UAV is connected to the first mobile terminal to perform wireless communication, the controller transmits a control request signal to a second mobile terminal different from the first mobile terminal on the basis of at least one of connected signal strength and receiving of a preset control signal.

In an embodiment, the controller may receive at least one terminal information from the first mobile terminal, and the second mobile terminal may be determined based on the at least one terminal information.

In an embodiment, priority may be set in the at least one terminal information, and the controller may transmit the control request signal based on the priority.

In an embodiment, the UAV may further include: a camera, wherein the controller may recognize an image related to a face included in an image received through the camera, and determine the second mobile terminal based on terminal information associated with the recognized image.

In an embodiment, the controller may receive at least one terminal information from the first mobile terminal, and when priority related to the second mobile terminal is set in the at least one terminal information, the controller may determine the second mobile terminal based on the recognized image and the priority.

In an embodiment, when terminal information associated with the recognized image and terminal information determined based on the priority are different, the priority may be changed based on the terminal information associated with the recognized image.

In an embodiment, when the determined second mobile terminal is connected to perform wireless communication, the controller may transmit at least one image captured through the camera to the second mobile terminal.

In an embodiment, when a control approval signal for the control request signal is received from the second mobile terminal, the controller may perform a function corresponding to a control signal received from the second mobile terminal instead of the first mobile terminal.

In an embodiment, the UAV may further include: a wing part, wherein when the control request signal is transmitted, the controller may control the wing part to maintain flight at a point where the UAV is positioned at the time of transmitting the control request signal, until the control approval signal is received.

In an embodiment, when the control approval signal is received, the controller may transmit notification information indicating that a mobile terminal capable of controlling the UAV has been changed to at least one of the first and second mobile terminals.

In an embodiment, when the control approval signal is received, the communication unit may connect the UAV to perform wireless communication with the second mobile terminal, and when a control right request signal is received from the first mobile terminal in a state that the UAV is connected to perform wireless communication with the second mobile terminal, the controller may release the connection to the second mobile terminal and control the communication unit to connect the UAV to the first mobile terminal.

In an embodiment, the connection to the second mobile terminal may be released based on an approval signal received from the second mobile terminal when a control right request signal is received from a third mobile terminal different from the first mobile terminal, and when a control right request signal is received from the first mobile terminal, the connection to the second mobile terminal may be released without the approval signal.

Another exemplary embodiment of the present invention provides a mobile terminal including: a communication unit performing wireless communication with an unmanned aerial vehicle (UAV); and a controller generating at least one terminal information capable of controlling the UAV based on a user request and controlling the communication unit to transmit the generated terminal information to the UAV.

In an embodiment, the mobile terminal may further include: a sensing unit sensing movement of the mobile terminal, wherein when a preset movement is sensed through the sensing unit in a state that the mobile terminal is connected to the UAV to perform wireless communication, the controller may transmit a preset control signal related to control to the UAV.

In an embodiment, the preset movement may be a movement that the mobile terminal moves by a predetermined distance or greater within a reference time, and the preset control signal related to control may be a signal indicating that it is impossible to control the UAV.

Another exemplary embodiment of the present invention provides a mobile terminal including: a communication unit performing wireless communication with an unmanned aerial vehicle (UAV); a display unit; and a controller displaying screen information corresponding to a control request signal when the control request signal is received from the UAV, and controlling the communication unit to transmit a control approval signal for the control request signal to the UAV based on a user request, wherein the communication unit is connected with the UAV to perform wireless communication when the control approval signal is transmitted, and screen information received from the UAV is displayed on the display unit.

In an embodiment, a preview image received through a camera provided in the UAV and at least one image previously captured through the camera may be displayed on the display unit.

In an embodiment, information of at least one terminal capable of controlling the UAV may be displayed on the display unit, and when any one of the terminal information is selected, the controller may transmit the selected terminal information to the UAV so that the UAV may transmit a control request signal to a mobile terminal corresponding to the selected terminal information.

In an embodiment, when the mobile terminal corresponding to the selected terminal information and the UAV are connected to perform wireless communication, notification information indicating that the mobile terminal capable of controlling the UAV has been changed may be displayed on the display unit.

Another exemplary embodiment of the present invention provides a method for controlling an unmanned aerial vehicle (UAV), including: connecting the UAV to perform wireless communication with a first mobile terminal; and transmitting a control request signal to a second mobile terminal different from the first mobile terminal based on at least one of the connected signal strength and receiving a preset control signal in a state that the UAV is connected to perform wireless communication with the first mobile terminal.

The present invention may provide an optimized control method capable of controlling an unmanned aerial vehicle using a second mobile terminal different from a first mobile terminal when a connection signal strength between the first mobile terminal controlling the unmanned aerial vehicle and the unmanned aerial vehicle is weak or when the first mobile terminal enters an uncontrollable state.

Further, the present invention provides a control method whereby when selecting the second mobile terminal different from the first mobile terminal, the second mobile terminal is selected based on not only the priority set by the user but also an image captured by the unmanned aerial vehicle, thus selecting the second mobile terminal that may control the unmanned aerial vehicle more stably.

In addition, in the present invention, when a mobile terminal capable of controlling an unmanned aerial vehicle is changed from the first mobile terminal to the second mobile terminal, an image captured under the control of the first mobile terminal may be checked in the second mobile terminal. Thus, the user may easily and simply recognize a previously captured area and an area to be captured.

In addition, the present invention may provide a UI/UX capable of more easily changing a mobile terminal capable of controlling an unmanned aerial vehicle according to a user request.

### BRIEF DESCRIPTION OF THE DRAWINGS

FIG. 1A is a block diagram illustrating a mobile terminal related to the present invention.

FIGS. 1B and 1C are conceptual views of an example of a mobile terminal related to the present invention, viewed from different directions.

FIG. 2 is a conceptual view illustrating an unmanned aerial vehicle (UAV) related to the present invention.

FIG. 3 is a flow chart illustrating a method for controlling UAV and a mobile terminal.

FIGS. 4A and 4B are conceptual views illustrating a method for setting a mobile terminal capable of controlling a UAV of the present invention.

FIGS. 5A and 5B are conceptual views illustrating a method for changing a mobile terminal controlling a UAV by the unmanned aerial vehicle.

FIGS. 6A, 6B, and 6C are conceptual views illustrating a method for changing a mobile terminal that controls a UAV on the basis of a user request by a mobile terminal of the present invention.

FIGS. 7 and 8 are conceptual views illustrating a control method for controlling a UAV of the present invention to land.

FIG. 9 is a conceptual view illustrating a user interface related to control of a UAV to an embodiment of the present invention.

### MOPES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

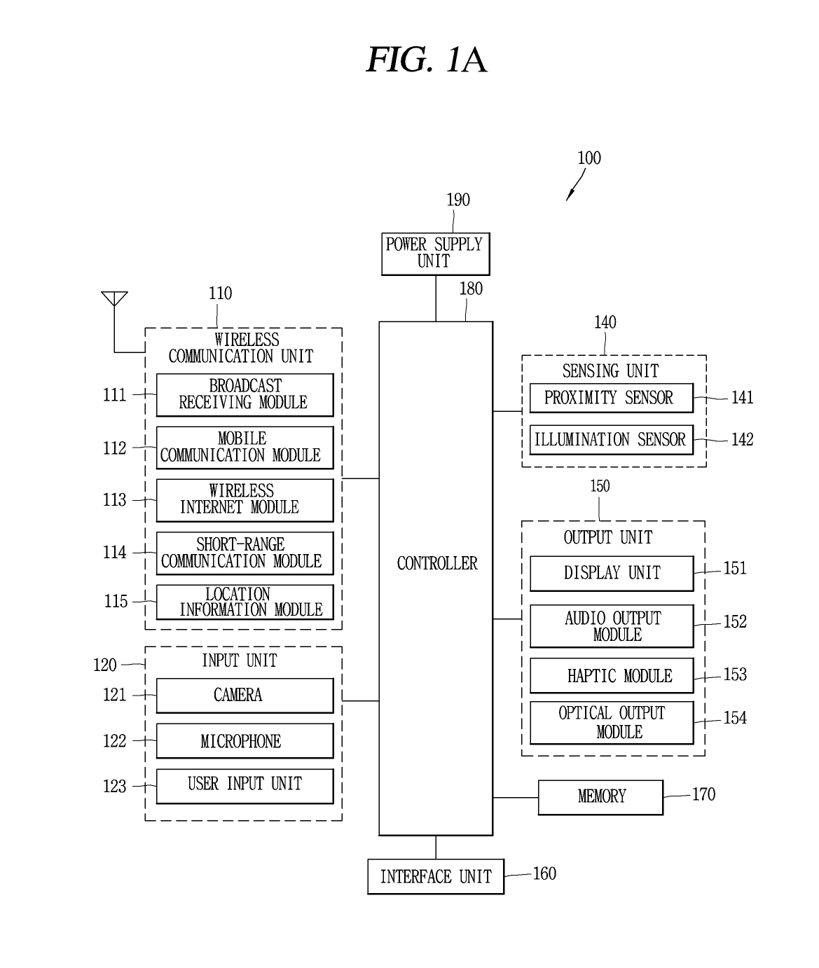

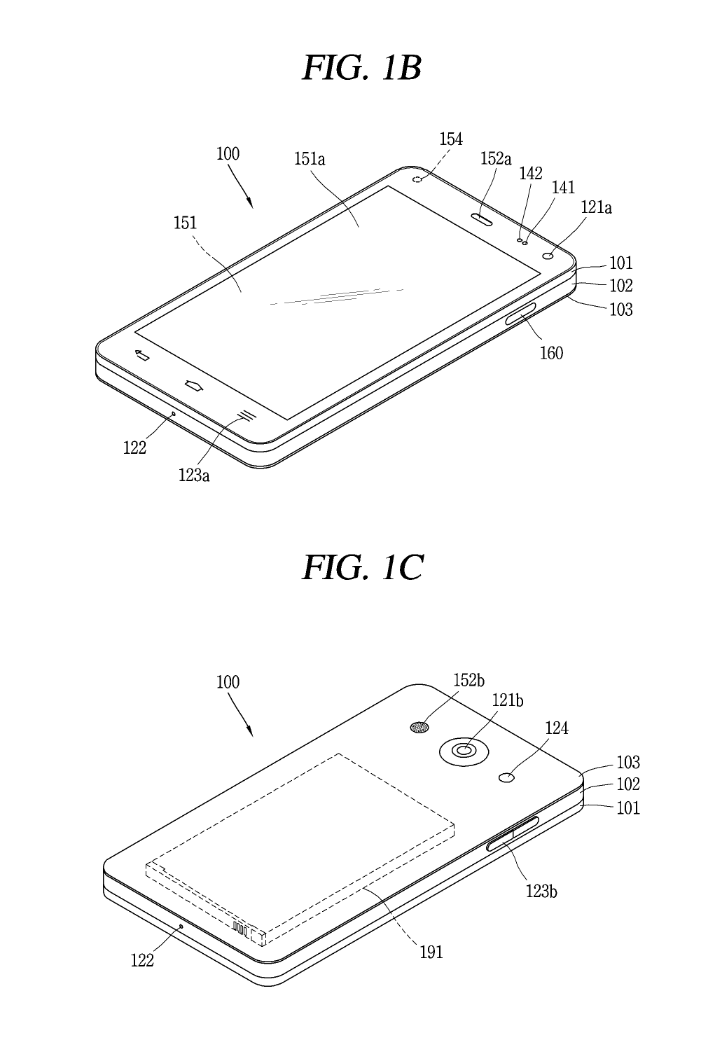

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 180, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 is shown having a proximity sensor 141 and an illumination sensor 142. If desired, the sensing unit 140 may alternatively or additionally include other types of sensors or devices, such as a touch sensor an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 180.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components, or activating application programs stored in the memory 170.

The controller 180 controls some or all of the components illustrated in FIG. 1A in order to drive an application program stored in the memory 170. Further, the controller 180 may operate at least two of the components of the mobile terminal 100 in order to drive the application program.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method for a mobile terminal according to various embodiments to be explained later. The operation or the control method for the mobile terminal may be implemented on the mobile terminal by driving at least one application program stored in the memory 170.

Before explaining various embodiments of the mobile terminal 100, the aforementioned components will be explained in more detail with reference to FIG. 1A.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Mulls Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both, if desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input, image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the users fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 180 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The terminal body may be understood as at least one assembly of the mobile terminal 100.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal may be provided with a display unit 151, first and second audio output modules 152a, 152b, a proximity sensor 141, an illumination sensor 142, an optical output module 154, first and second cameras 121a, 121b, first and second manipulation units 123a, 123b, a microphone 122, an interface 160, etc.

Hereinafter, as shown in FIGS. 1B and 1C, will be explained the mobile terminal 100 having the display unit 151, the first audio output module 152a, the proximity sensor 141, the illumination sensor 142, the optical output module 154, the first camera 121a and the first manipulation unit 123a on the front surface of the terminal body, having the second manipulation unit 123b, the microphone 122 and the interface unit 180 on the side surfaces of the terminal body, and having the second audio output module 152b and the second camera 121b on the rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. For example, the display unit 151 may display execution screen information of an application program executing at the mobile terminal 100 or user interface (UI) and graphic user interface (GUI) information in response to the execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate if using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 180 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 180 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for calf communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

As previously described with regard to FIG. 1A, the mobile terminal may be configured to include short-range communication techniques such as Bluetooth™, Radio Frequency Identification (RFID), infrared Data Association (IrDA), Ultra Wideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, if a mobile terminal having card information on a payment card (e. g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In this case, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Reference will now be made in detail to the preferred embodiments of a control method of a mobile terminal according to the present invention, examples of which are illustrated in the accompanying drawings. It will also be apparent to those skilled in the art that various modifications and variations can be made in the present invention without departing from the spirit or scope of the invention.

A mobile terminal of the present invention which may include at least one of the components described above may control an unmanned aerial vehicle 1000.

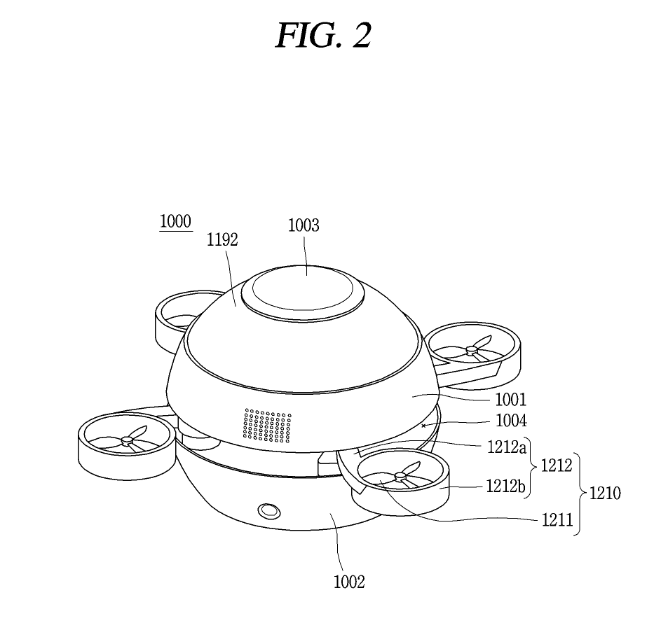

Hereinafter, the unmanned aerial vehicle 1000 related to the present invention will be described in detail with reference to FIG. 2.

The unmanned aerial vehicle (UAV) 1000 related to the present invention is a flying object manufactured to perform a designated mission without carrying a pilot (person). The unmanned aerial vehicle 1000 may be called a drone, an unmanned aerial equipment, a unmanned aerial object, or the like.

Hereinafter, the description of the UAV 1000 may be inferred and applied to an apparatus that is operated on the ground or operated at sea, as well as an apparatus (object equipment) that performs flight, in the same or similar manner.

Also, hereinafter, the description of the UAV 1000 may be inferred and applied to an object in which a pilot (human) is aboard, such as a manned aircraft, a vehicle, or the like, in the same/similar manner.

The UAV 1000 (or a drone) related to the present invention may include at least one of the components described in FIGS. 1A to 1C.

For example, the UAV 1000 may include a wireless communication unit. The UAV 1000 may exchange (transmit and receive) data through the wireless communication unit 110 and the wireless communication unit 110 included in the mobile terminal 100.

The UAV 1000 may include an upper case 1001 a lower case 1002, a receiving part 1004, a wing part 1210, a camera 1121, and a controller. Hereinafter, a reference numeral 1180 will be used for the controller of the UAV 1000.

The upper case 1001 and the tower case 1002 provide a space for various components for implementing the UAV 1000. At least one of the components described in FIG. 1A, for example, an electronic component such as a controller, a sensing unit, a user input unit, an audio output unit, a microphone, and the like, may be mounted on the upper case 1001 and the lower case 1002. The upper case 1001 and the lower case 1002 may be referred to as a body part of the drone.

The receiving part 1004 is formed between the upper case 1001 and the lower case 1002 and the wing part 1210 is received in the receiving part 1004. The wing part 1210 may include at least one wing unit. Although the wing 1210 is illustrated as including four wing units, the number of wing units is not limited thereto.

The wing part 1210 may be formed of a propeller 1211 and a main body 1212 including the propeller 1211. The main body 1212 may include at least one of a connection part 1212a connected to the body part and a fixing part 1212b to which the propeller 1211 is rotatably fixed. The wing part 1210 Includes a movable shaft (not shown) for rotatably connecting the connection part 1212a included in the main body 1212.

One area of the main body 1212 is curved so as to be continuously formed with outer surfaces of the upper and lower cases 1001 and 1002 in a receiving mode. When the receiving mode is switched to a flight mode, the movable shaft rotatably moves the connection part 121a so that the wind unit protrudes to the outside of the body part and the fixing part 1212b is disposed on the outside. When the propeller 1211 rotates in the flight mode, the body part flies.

The controller 1180 of the UAV 1000 may control the wing part 1210 based on a request from the mobile terminal 100. Specifically, when a signal requesting movement in one direction is received from the mobile terminal 100, the controller 1180 of the UAV 1000 may control the wing part 1210 so that the UAV 1000 may move in the one direction.

In addition, the UAV 1000 related to the present invention may be equipped with a camera 1121. At least one camera 1121 may be provided.

The controller may transmit a preview image received through the camera 1121 to an external device through a wireless communication unit. For example, the external device may be the mobile terminal 100 related to the present invention.

Here, the preview image refers to an image which is continuously output after received through the camera 1121 according to the flow of time.

The controller 1180 of the UAV 1000 may transmit the preview image received through the camera 1121 to the mobile terminal 100 through the wireless communication unit based on a request from the mobile terminal 100. Accordingly, a preview image received through the camera 1121 of the UAV may be displayed on the mobile terminal 100.

In addition, the UAV 1000 may transmit the preview image to a plurality of mobile terminals 100 through a wireless communication unit. The plurality of mobile terminals 100 may be determined based on terminal information transmitted from the mobile terminal 100 capable of controlling the UAV 1000. In this case, the preview images may be displayed on the plurality of mobile terminals 100, respectively.

The controller 1180 of the UAV 1000 may control the camera 1121 based on a request from the mobile terminal 100. For example, when a request to perform a zoom-in function of the camera is received from the mobile terminal 100, the controller 1180 of the UAV 1000 may control the camera 1121 to perform the zoom-in function and transmit a preview image changed by the zoom-in function to the mobile terminal 100.

Here, it is obvious that the UAV 1000 may be controlled not only based on a request of the mobile terminal 100 but also by a remote controller, a mobile terminal, a fixed terminal, etc., which may control the UAV 1000.

Meanwhile, the mobile terminal 100 related to the present invention may control the UAV 1000 described in FIG. 2 in various ways. Hereinafter, a method of controlling the UAV 1000 described with reference to FIG. 2 using the mobile terminal 100 shown in FIGS. 1A to 1C will be described in detail with reference to the accompanying drawings.

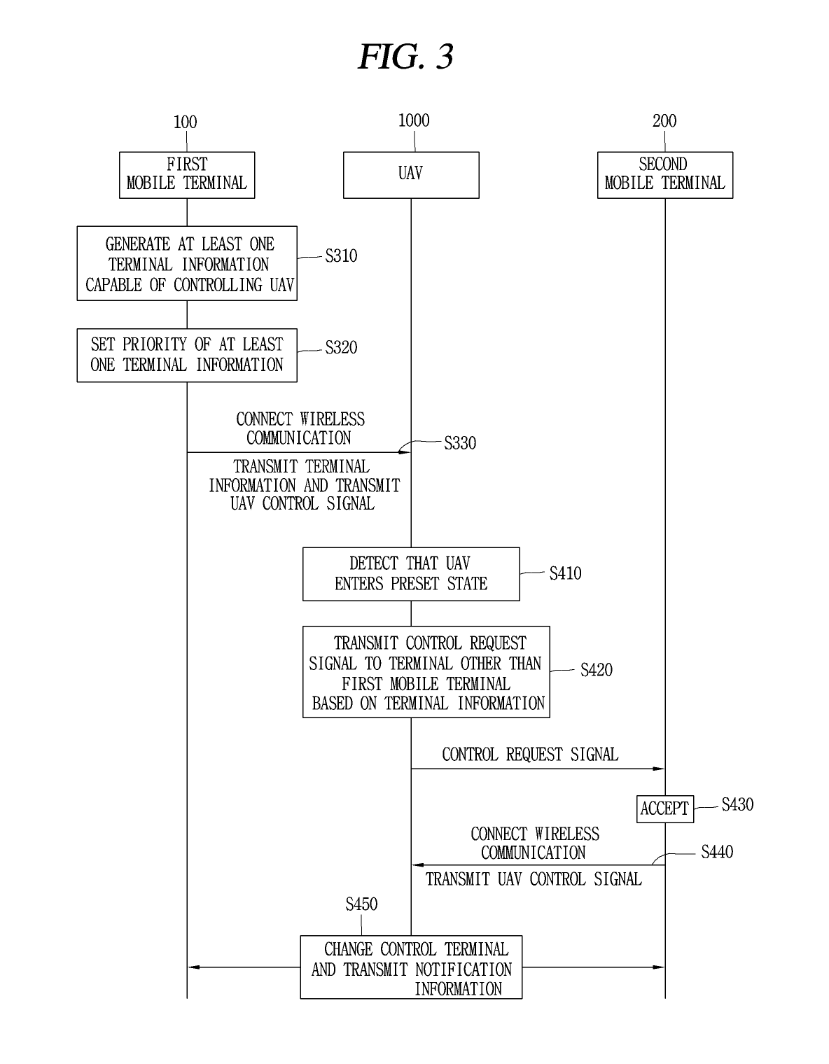

FIG. 3 is a flowchart illustrating a method for controlling a UAV and a mobile terminal of the present invention.

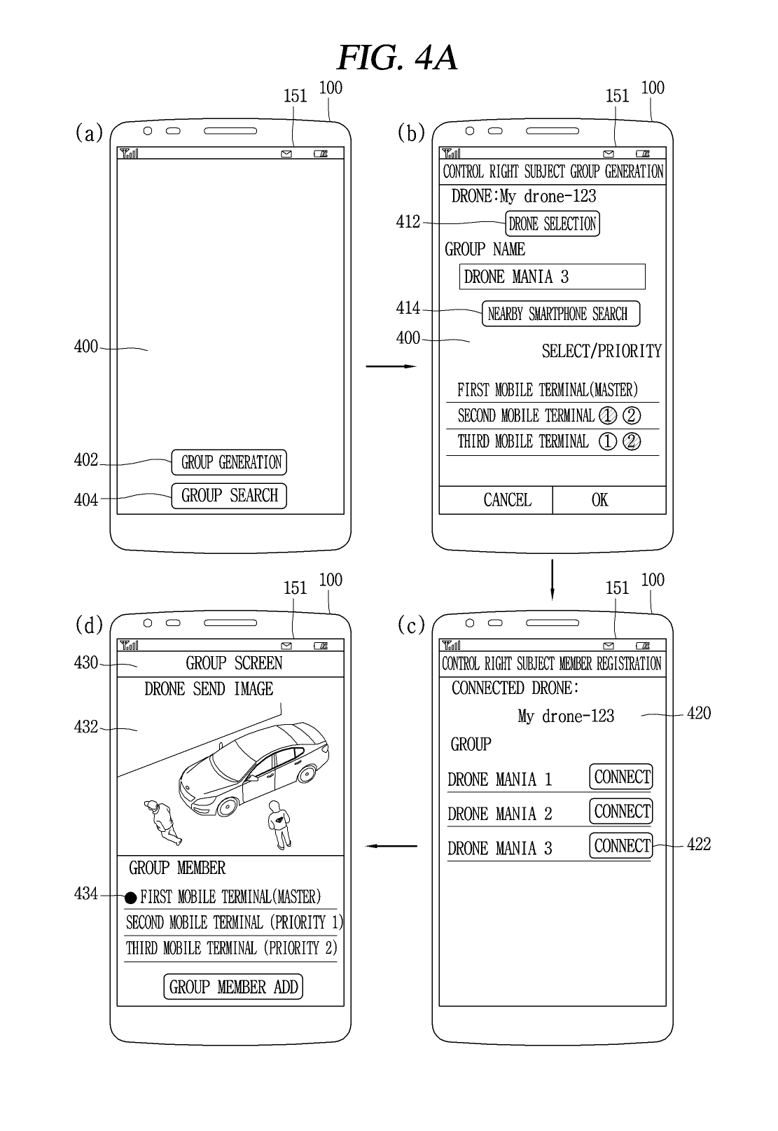

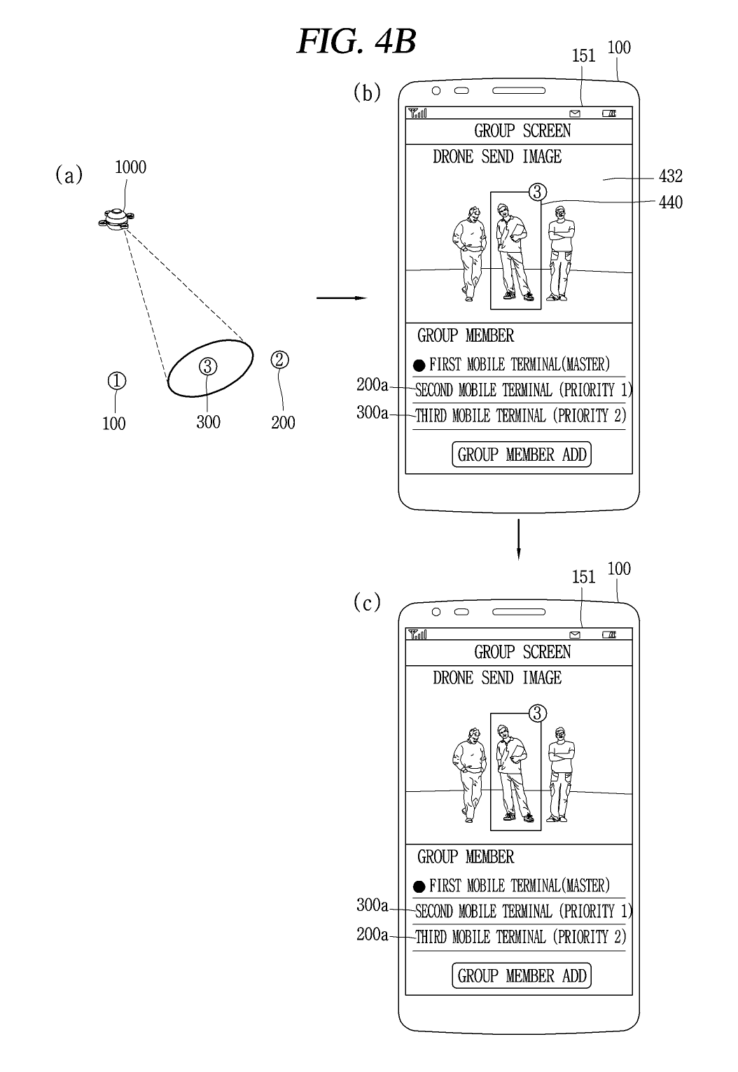

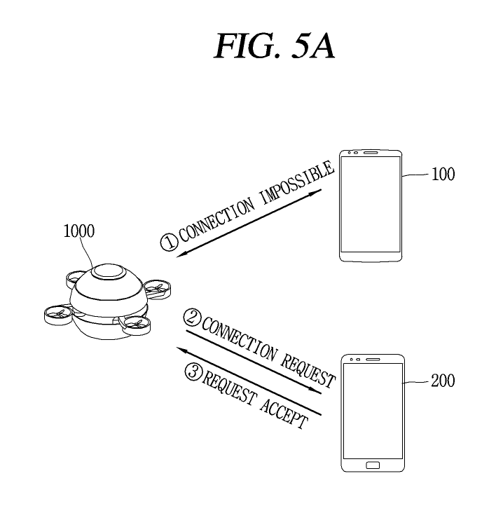

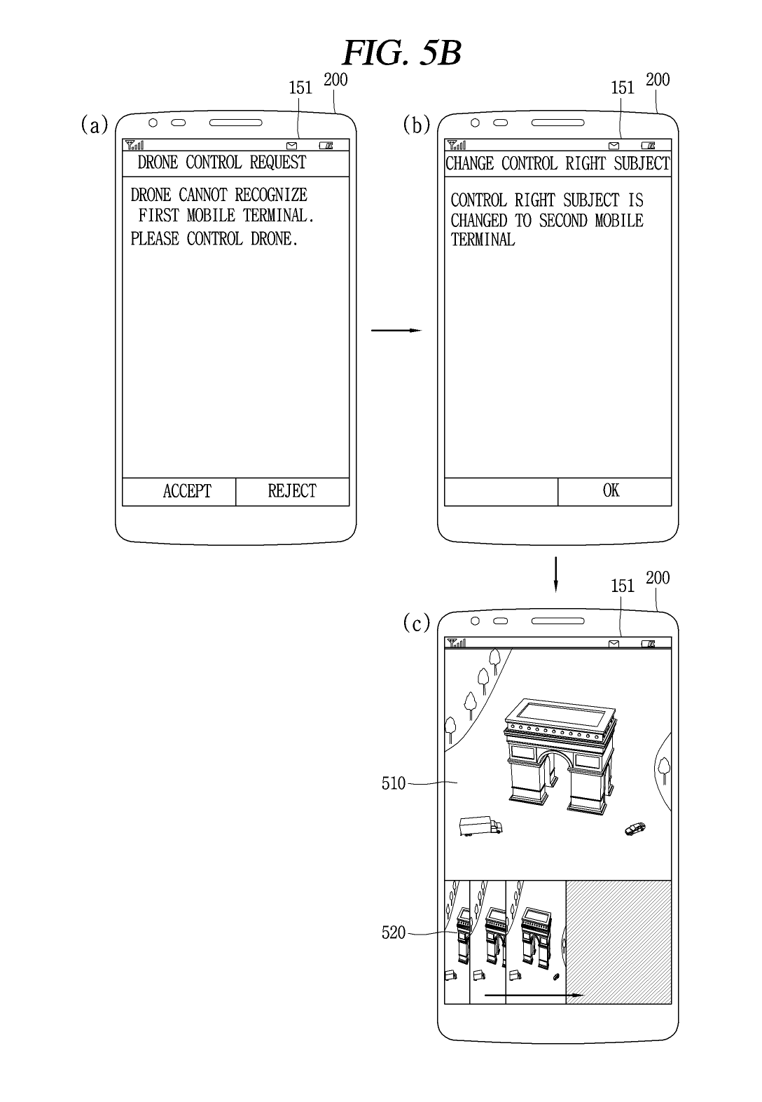

FIGS. 4A and 4B are conceptual diagrams illustrating a method of setting a mobile terminal capable of controlling a UAV of the present invention, and FIGS. 5A and 5B are diagrams illustrating a method for changing a mobile terminal for controlling a UAV of the present invention by the UAV.

The UAV 1000 related to the present invention may be controlled by at least one mobile terminal 100 or 200. Specifically, the UAV 1000 is controlled by one of a plurality of mobile terminals and may be controlled by another mobile terminal different from the mobile terminal based on a user request or a preset algorithm. As another example, the UAV 1000 may be simultaneously controlled by a plurality of mobile terminals 100.

Hereinafter, at least one mobile terminal capable of controlling the UAV 1000 will be referred to as a first mobile terminal 100, a second mobile terminal 200, and the like.

The first mobile terminal 100 and the second mobile terminal 200 may include at least one of the components described in FIGS. 1A to 1C. When the first mobile terminal 100 is referred to as a ‘mobile terminal’, the second mobile terminal 200 may be referred to as an ‘external terminal’, an ‘external device’, or the like.

In addition, the configurations and features of the first and second mobile terminals 100 and 200 may be performed in one mobile terminal related to the present invention.

Referring to FIG. 3, in the present invention, a step of generating at least one terminal information in which the first mobile terminal 100 is capable of controlling a UAV is performed (S310).

The mobile terminal 100 related to the present invention may be provided with (installed) an application associated with a function of controlling the UAV 1000. The application may include various functions related to the UAV 1000, for example, a function of connecting the UAV 1000 and the mobile terminal 100 to each other to perform wireless communication, a function of outputting a preview image to the display unit 151 of the mobile terminal 100, a function of controlling the UAV based on a user control command (or user input) input to the mobile terminal 100, or the like.

In addition, the mobile terminal 100 may generate at least one terminal information capable of controlling the UAV 1000 through an application.

Hereinafter, a method for generating the at least one terminal information will be described in more detail with reference to FIG. 4A.

As shown in (a) of FIG. 4A, when an application associated with the function of controlling the UAV 1000 is executed, first screen information 400 may be output on the display unit 151 of the mobile terminal 100.

For example, the first screen information 400 may include an icon 402 associated with a function of generating at least one terminal information and an icon 404 associated with a function of transmitting information of the mobile terminal 100 so that an external terminal may generate the terminal information by using the information of the mobile terminal 100.

When the icon 402 associated with the function of generating at least one terminal information is selected, the controller 180 may output second screen information 410 related to the application on the display unit 151 as illustrated in (b) of FIG. 4A.

The second information 410 may include information of a UAV to be controlled (that is, a control object) (e.g., a name of the UAV, a unique number, a product number, etc.), an icon 142 associated with a function of selecting (searching) the UAV to be controlled, a group name representing the at least one terminal information, an icon 414 associated with a function of searching for a mobile terminal, at least one searched terminal information, and a graphic object for setting priority of the at least one mobile terminal.

For example, as shown in (b) of FIG. 4A, when the icon 414 associated with the function of searching for the mobile terminal is selected in the first mobile terminal 100, the at least one of searched mobile terminal information may be displayed on the display unit 151.

As illustrated in (a) of FIG. 4A, the mobile terminal information may be information on mobile terminals in which the icon 404 associated with the function of transmitting the mobile terminal information to be used in generating the terminal information at the external terminal is selected.

For example, if the icon 404 is selected in the second mobile terminal and the third mobile terminal, the second mobile terminal and the third mobile terminal may transmit respective mobile terminal information through the communication unit.

The first mobile terminal 100 activates the communication unit 110 based on selection of the icon 414 associated with the function of searching for the mobile terminal and receives the mobile terminal information through the communication unit. Then, the controller 180 may output the received mobile terminal information to the display unit 151.

Returning to FIG. 3, in the present invention, a step of setting priority of at least one terminal information may proceed (S320).

In the display unit 151 (for example, in the vicinity of the received mobile terminal information), a graphic object for setting priority of the received mobile terminal information may be displayed. The controller 180 may set priority of the received mobile terminal information based on user input applied to the graphic object.

Also, as illustrated in (b) of FIG. 4A, the controller 180 may set priority based on the user selection simultaneously when the received mobile terminal information is selected. That is, mobile terminal information in which the graphic object is not selected may not be included in at least one terminal information capable of controlling the UAV.

When the selection and prioritization of the received mobile terminal information are completed, the controller 180 may generate at least one terminal information capable of controlling the UAV. The at least one terminal information may be grouped into one group.

When prioritization of the received mobile terminal information is completed, third display information 420 related to an application associated with the function of controlling the UAV 1000 may be output to the display unit 151. As shown in (c) of FIG. 4A, the third screen information 420 may include UAV information to be controlled, a group name in which at least one terminal information capable of controlling the UAV is grouped, and an icon 422 associated with a function of connecting to perform a wireless communication with the UAV corresponding to the UAV information, and the like.

Returning to FIG. 3, in the present invention, a step of connecting the mobile terminal (the first mobile terminal 100) and the UAV 1000 to perform wireless communication is performed (S330).

Here, connection between the mobile terminal and the UAV 1000 to perform wireless communication means that a control right that may control the UAV 1000 is set (registered, designated) in the mobile terminal.

For example, the controller 180 of the first mobile terminal 100 may control the communication unit 110 to perform wireless communication with the UAV 1000 based on a user request.

As shown in (c) of FIG. 4A, the user request may be, for example, selecting an icon 422 associated with the function of connecting to perform wireless communication with the UAV.

Specifically, when the icon 422 is selected, the controller 180 may activate the communication unit 110 and emits a signal for connection with the UAV. When a response signal is received from the UAV that receives the signal, the first mobile terminal 100 and the UAV 1000 may be connected to each other to perform wireless communication.

In a state where the first mobile terminal 100 and the UAV 1000 are connected to each other, a signal for maintaining the connection may be transmitted and received periodically or at predetermined time intervals.

Also, the icon 422 may be associated with at least one terminal information capable of controlling the UAV. The controller 180 of the first mobile terminal 100 may transmit the at least one terminal information associated with the icon 422 to the UAV 1000 when the icon 422 is selected.

Also, the controller 180 of the first mobile terminal 100 may transmit a control signal for controlling the UAV 1000 to the UAV 1000 through the communication unit 110 (or through wireless communication).

The UAV 1000 receiving the control signal may perform a function corresponding to the control signal based on the control signal received from the first mobile terminal 100. For example, the controller 1180 of the UAV 1000 may control movement of the UAV and a camera and the like provided on the UAV, based on the control signal received from the first mobile terminal 100.

The controller 1180 of the UAV 1000 may transmit a preview image received through the camera 1121 to the first mobile terminal 100 in a state where the first mobile terminal 100 and the UAV 1000 are connected to perform wireless communication.

As illustrated in (d) of FIG. 4A, the display unit 151 of the first mobile terminal 100 may display fourth screen information 430 related to an application associated with the function of controlling the UAV 1000.

A preview image 432 received from the UAV 1000 and at least one terminal information transmitted to the UAV 1000 may be displayed on the fourth screen information 430. Also, an indicator 434 indicating a mobile terminal currently controlling the UAV 1000 may be displayed in any one of the at least one terminal information.

For example, when the indicator 434 is displayed in the first mobile terminal information, the UAV 1000 may be controlled by the first mobile terminal 100 corresponding to the first mobile terminal information. Being controlled by the first mobile terminal 100 may mean performing a function corresponding to a control signal received from the first mobile terminal 100.

In addition, information indicating priority of the at least one terminal information may be displayed in the fourth screen information 430. The priority means order of transmitting a signal requesting control by the UAV 1000 to a mobile terminal different from the first mobile terminal when it is determined that the UAV 1000 cannot be controlled by the first mobile terminal 100.

Meanwhile, the priority may be changed by the controller 1180 of the UAV 1000. Specifically, the controller 1180 of the UAV 1000 may change priority set for at least one terminal information received from the first mobile terminal 100, based on a preset algorithm (or method).

For example, the controller 1180 of the UAV 1000 may transmit a response request signal (e.g., RF (radio frequency) signal) to mobile terminals corresponding to the at least one terminal information. Thereafter, the controller 1180 of the UAV 1000 may change the priority based on strength of a response signals (e.g., RF signals) transmitted from the mobile terminals. For example, the controller 1180 may set a higher priority from mobile terminal information corresponding to a mobile terminal having a greater strength of the response signal.

As another example, the controller 1180 of the UAV 1000 may change priority set in at least one terminal information transmitted from the first mobile terminal 100 based on an image (preview image) received through the camera 1121 included in the UAV 1000.

Hereinafter, a method of changing priority based on an image received through the camera 1121 will be described with reference to FIG. 4B.

In FIG. 4B, it is assumed that second mobile terminal information 200a corresponding to the second mobile terminal 200 and third mobile terminal information 300a corresponding to the third mobile terminal 300 are included in at least one terminal information transmitted from the first mobile terminal 100. It is also assumed that the second mobile terminal information 200a has a first priority and the third mobile terminal information 300a has a second priority.

As shown in (a) of FIG. 4B, based on an image received through the camera 1121 of the UAV 1000, the controller 1180 of the UAV 1000 may recognize an image related to a face included in the image.

Thereafter, the controller 1180 of the UAV 1000 may change the priority based on the recognized image. Specifically, an image related to the face may be associated with the at least one terminal information.

The controller 1180 may extract an image 440 related to the face included in the image based on an image 432 received through the camera 1121. The controller 1180 may extract (determine) terminal information associated with the image 440 related to the extracted face in the at least one terminal information, based on the extracted image 440 related to the face. Thereafter, the controller 1180 may change the priority order based on the extracted terminal information.

For example, as shown in FIG. 4B, when the image 440 related to the face recognized in the image 432 received through the camera 1121 corresponds an image related to the face associated with the third mobile terminal information 300a, the controller 1180 of the UAV 1000 may change the priority of the third mobile terminal information 300a as shown in (c) of FIG. 4B.

For example, in a state that lie second mobile terminal information 200a has a first priority and the third mobile terminal information 300a has a second priority, when the image 440 related to the face recognized in the image 432 received through the camera corresponds to the image related to the face associated with the third mobile terminal information 300a, the controller 1180 may change the third mobile terminal information 300a to a first priority and the second mobile terminal 200a to a second priority.

The controller 1180 of the UAV 1000 may transmit information related to the priority order (for example, information related to the changed priority) to the mobile terminal corresponding to at least one mobile terminal information. In this case, as shown in (c) of FIG. 4B, priority of the at least one mobile terminal information may be changed and displayed on the display unit 151 of the mobile terminal corresponding to at least one mobile terminal information as shown in \textcircled{c} of FIG. 4B.

Also, when a priority is not set in at least one terminal information transmitted from the first mobile terminal 100, the controller 1180 of the UAV 1000 may set a priority based on an image received through camera 1121 of the UAV or determine a second mobile terminal to transmit a control request signal.

Through the configuration, in the present invention, a priority may be set based on an image received through the camera of the UAV or a second mobile terminal to transmit a control request signal may be determined, thereby remarkably enhancing reliability and accuracy related to transmission of a control request signal.

Meanwhile, the fourth screen information 430 may be displayed together in at least one mobile terminal corresponding to the at least one terminal information, as well as in the first mobile terminal 100. For example, when the first mobile terminal 100 and the UAV 1000 are connected to perform wireless communication, the fourth screen information 400 may also be displayed on the display unit 151 of at least one mobile terminal (e.g., the second mobile terminal, the third mobile terminal) corresponding to the at least one terminal information.

Meanwhile, the mobile terminal (for example, the first mobile terminal) connected for the first time to perform wireless communication with the UAV 1000 among the at least one mobile terminal may have a higher (greater) control right (grade, level, etc.) than the mobile terminal. That is, the first connected mobile terminal (or the mobile terminal that transmitted at least one terminal information) may be referred to as a master terminal and the remaining mobile terminals (for example, the second mobile terminal and the third mobile terminal) may be referred to as slave terminals.

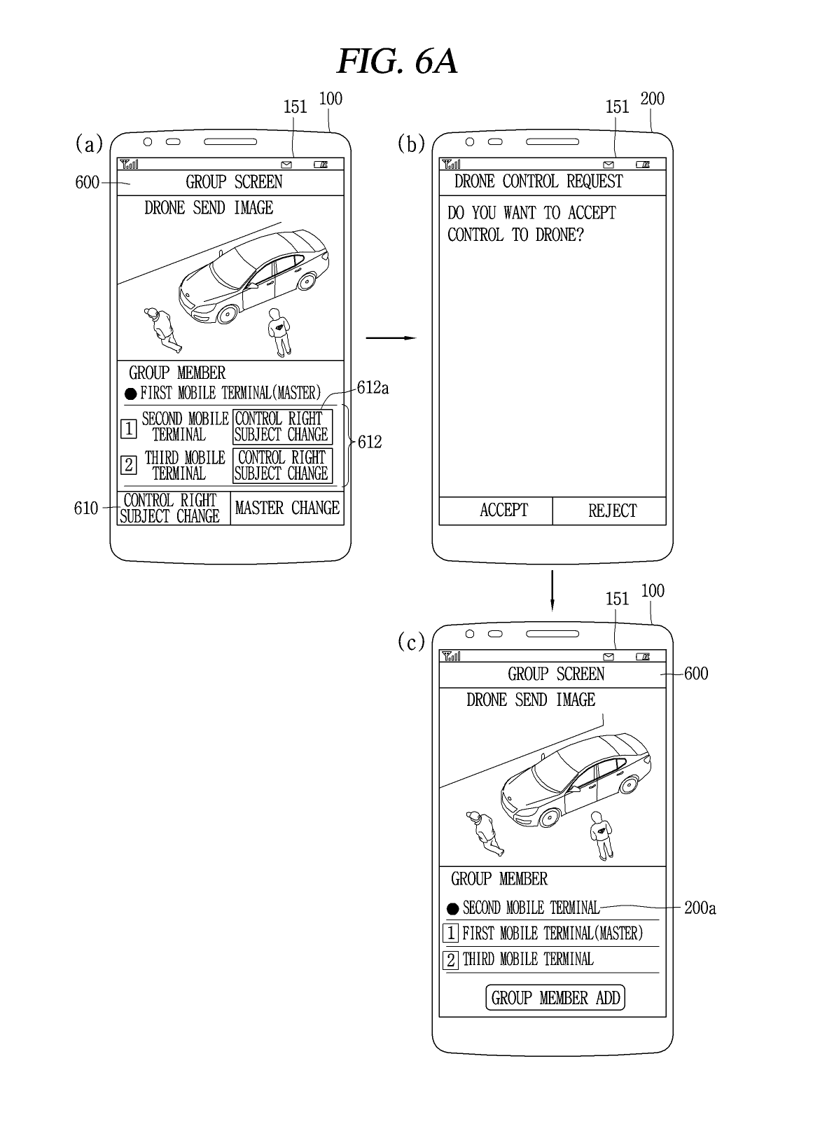

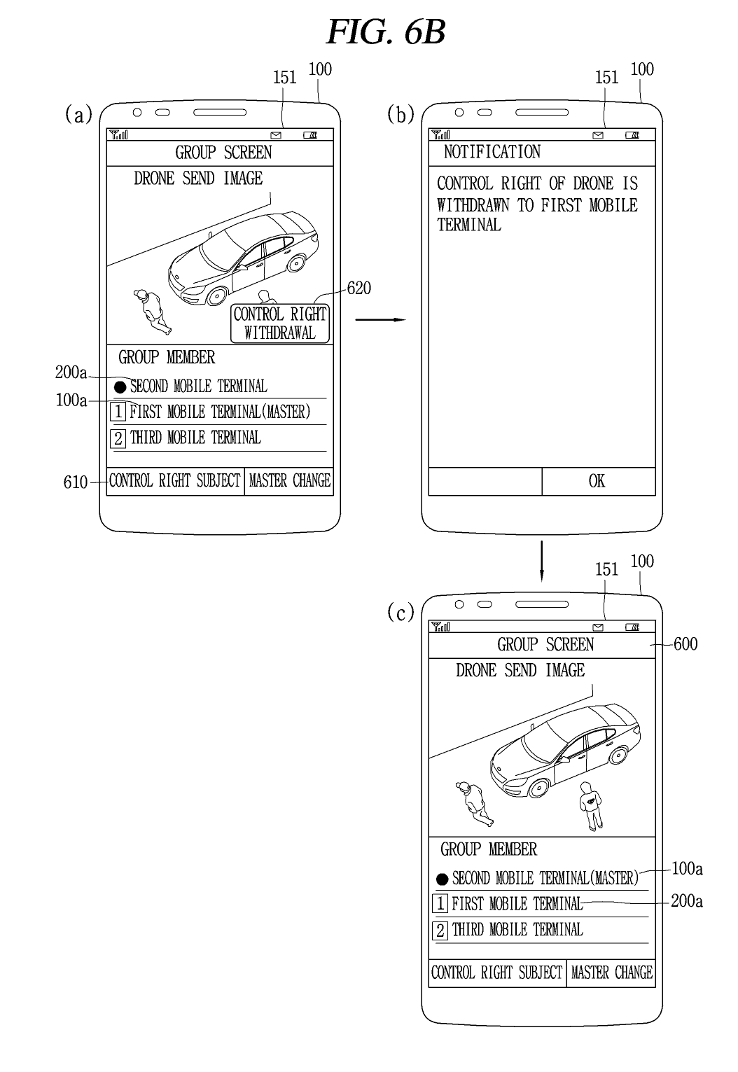

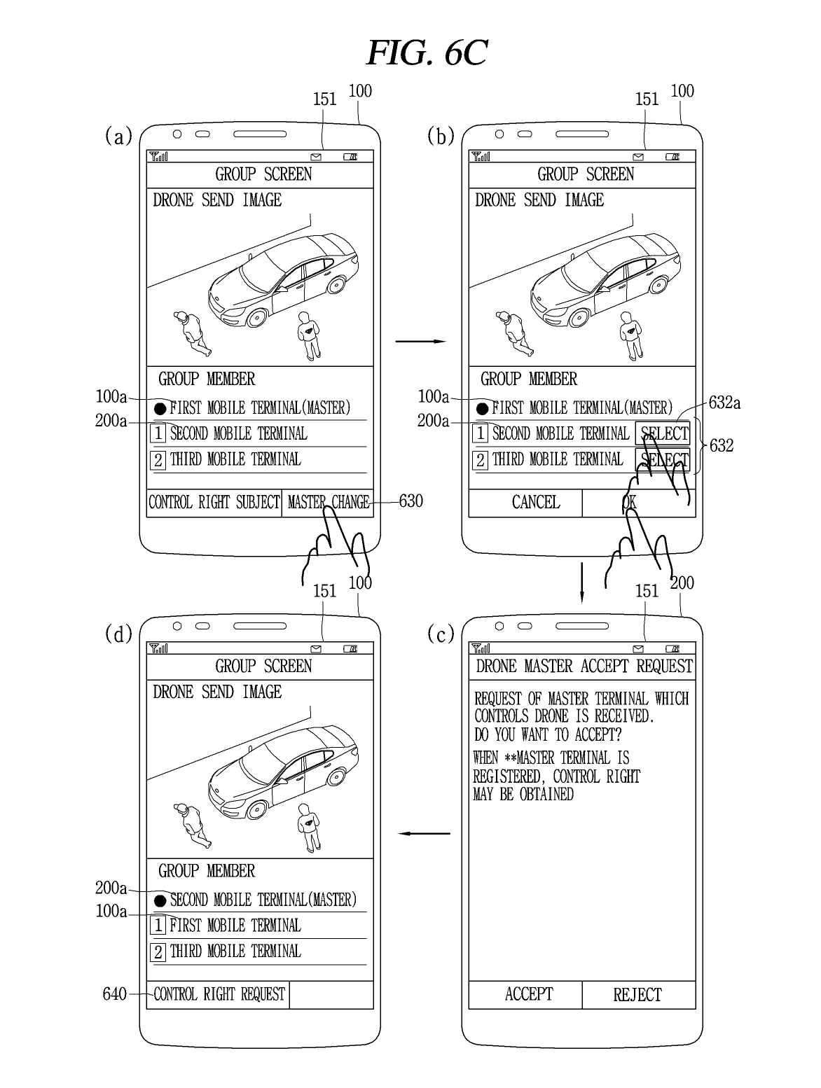

The master terminal may be the first connected mobile terminal or may have previously been set in at least one terminal information transmitted to the UAV 1000. Also, the master terminal may be changed based on a user request. In addition, the control right of the master terminal may be withdrawn without an approval (acceptance), while the UAV 1000 is being controlled by the slave terminal (the related contents will be described in more detail with reference to FIG. 6C).

Although not shown, a graphic object associated with a function of controlling movement of the UAV 1000 and a graphic object associated with a function of controlling the camera of the UAV 1000 may be displayed on the display unit 151. For example, when a graphic object associated with a function of moving the UAV 1000 in the left direction is selected, the controller 180 of the first mobile terminal 100 may transmit a control signal associated with the graphic object, that is, a control signal for moving the UAV 1000 in the left direction, to the UAV 1000. The UAV 1000 may control the wing part so that the UAV 1000 may move in the left direction based on the control signal.

Returning to FIG. 3, in the present invention, a step of detecting that the UAV 1000 enters a preset state is performed (S410). The detection may be performed by the sensing unit or the controller 1180 provided in the UAV 1000. To the sensing unit, the configuration of the sensing unit 140 described in FIG. 1A may be inferred and applied in the same/similar manner.

Thereafter, in the present invention, when it is detected that the UAV enters the predetermined state, a signal requesting control to a terminal other than the first mobile terminal is transmitted based on at least one terminal information transmitted from the first mobile terminal 100 (S420).

Specifically, the controller 1180 of the UAV 1000 may detect that the UAV 1000 enters the preset state, in a state of being connected to perform wireless communication with the first mobile terminal 100.

The preset state may mean a state in which it is impossible to control by the first mobile terminal 100 connected to perform the wireless communication. For example, the preset state may be related to the connected signal.

For example, when strength of a connection signal connected to the first mobile terminal 100 to perform the wireless communication becomes weaker than a reference strength, the controller 1180 of the UAV 1000 may detect that the UAV enters the preset state.

The connection signal may be a signal connected to enable the UAV 1000 and the first mobile terminal 100 to be connected to perform wireless communication, and may be a signal transmitted/received periodically or at preset time intervals as described above.

For example, the strength of the connection signal may become weak when a distance between the first mobile terminal 100 and the UAV 1000 is increased or a factor (e.g., fog, dust, wind, etc.) disturbing wireless communication between the first mobile terminal 100 and the UAV 1000 is increased.

As another example, when a control signal is not received from the first mobile terminal 100 for a predetermined time, when the connection with the first mobile terminal 100 is cut off, or when a connection signal periodically transmitted and received to and from the first mobile terminal 100 is not received by a predetermined number of times (e.g., a state that it is impossible to control by the first mobile terminal), the controller 1180 of the UAV 1000 may detect that the UAV enters the preset state.

As another example, the controller 1180 of the UAV 1000 may detect that the UAV enters the preset state based on receiving a predetermined control signal from the first mobile terminal 100.

The preset control signal may be a control signal transmitted from the controller 180 of the first mobile terminal 100 when the first mobile terminal 100 enters a state in which control of the UAV 1000 is impossible.

For example, the first mobile terminal 100 may include a sensing unit 140 for sensing movement of the mobile terminal 100. When a preset movement is sensed through the sensing unit 140 in a state that the first mobile terminal 100 is connected to perform wireless communication with the UAV 1000, the controller 180 of the first mobile terminal 100 may transmit a preset control signal related to control to the UAV.

For example, the preset movement may correspond to a movement of separating the mobile terminal by the user. That is, the preset movement may be a movement in which the first mobile terminal moves by a predetermined distance or greater within a reference time.

Also, the preset control signal related to the control may be a signal informing that it is impossible to control the UAV 1000 by the first mobile terminal.

In summary, in a state that the UAV 1000 is connected to perform wireless communication with the first mobile terminal 100, the controller 1180 of the UAV 1000 may transmit a control request signal a second mobile terminal different from the first mobile terminal based on at least one of the connected signal strength and received predetermined control signal (or based on entering a predetermined state).

For example, as illustrated in FIG. 5A, in a state that the UAV 1000 and the first mobile terminal 100 are connected to perform wireless communication, when a preset state is detected (for example, when strength of a connection signal is weaker than a reference strength, when the connection is cut off, or when a preset control signal is received from the first mobile terminal), the controller 1180 of the UAV 1000 may transmit a control request signal requesting control to the second mobile terminal 200 different from the first mobile terminal 100 based on at least one terminal information transmitted from the first mobile terminal 100.

Thereafter, when the control approval signal is received from the second mobile terminal 200, the UAV 1000 may perform a function corresponding to the control signal transmitted from the second mobile terminal 200. That is, the UAV 1000 may be controlled by the second mobile terminal 200 rather than the first mobile terminal 100.

As described above, when the UAV is connected to the first mobile terminal 100 to perform wireless communication, the controller 1180 of the UAV may receive at least one terminal information capable of controlling the UAV 1000 from the first mobile terminal 100.

The second mobile terminal 200 may be determined based on the at least one terminal information. Priority information may be set in the at least one terminal information. The controller 1180 of the UAV 1000 may transmit the control request signal based on the priority.

For example, when the at least one terminal information includes the second mobile terminal information and the third mobile terminal information and a first priority is set in the second mobile terminal information and a second priority is set in the third mobile terminal information, the controller 1180 of the UAV 1000 may transmit the control request signal to the second mobile terminal corresponding to the second mobile terminal information.

When a control approval signal for the control request signal is received from the second mobile terminal, the controller 1180 may not transmit the control request signal to the third mobile terminal corresponding to the third mobile terminal information, On the other hand, if the control approval signal is not received within a reference time from the second mobile terminal, the controller 1180 may transmit the control request signal to the third mobile terminal.

On the other hand, the controller 1180 of the UAV 1000 may recognize an image related to a face included in the image, based on the image received through the camera 1121 of the UAV. Thereafter, the controller 1180 may determine a second mobile terminal different from the first mobile terminal, based on terminal information associated with the recognized image. Specifically, the controller 1180 may recognize (extract) an image related to a face included in the image using the image received through the camera 1121, and compare the image related to the recognized face and the image related to the face associated with at least one terminal information transmitted from the first mobile terminal. Thereafter, the controller 1180 may extract terminal information associated with the image related to the face corresponding to the image related to the recognized face and transmit the control request signal to the mobile terminal corresponding to the extracted terminal information.

As described above, when at least one terminal information is received from the first mobile terminal 100 and the priority is set in the at least one terminal information, the controller 1180 of the UAV 1000 may determine a second mobile terminal 200 different from the first mobile terminal 100 based on the recognized image and the priority.

As illustrated in FIG. 4B, if the terminal information (e.g., third mobile terminal information associated with the image related to the face recognized in the image) associated with the recognized image and the terminal information determined based on the priority (for example, the second mobile terminal information set to have first priority) are different, the priority may be changed based on the terminal information associated with the recognized image. That is, the first priority may be changed to the third mobile terminal information rather than the second mobile terminal information.

Thereafter, the controller 1180 of the UAV 1000 may transmit a control request signal to the mobile terminal (third mobile terminal) corresponding to the changed terminal information (e.g., third mobile terminal information).

Thereafter, referring to FIG. 3, when the second mobile terminal 200 receives a control request signal based on a user request (S430), the mobile terminal 200 accepts the control request signal on the basis of user request (S430), a control approval signal for the control request signal may be transmitted from the second mobile terminal 200 to the UAV 1000.

Thereafter, the second mobile terminal 200 and the UAV 1000 may be connected to each other to perform wireless communication. At this time, the connection between the UAV 1000 and the first mobile terminal 100 may be cut off, and the controller 180 of the UAV 1000 may periodically transmit a signal requesting connection to the first mobile terminal.

When the control approval signal for the control request signal is received from the second mobile terminal 200, the controller 1180 of the UAV 1000 may control the wireless communication unit to connect with the second mobile terminal 200 to perform wireless communication (S440).

The controller 1180 of the UAV 1000 may perform a function corresponding to the control signal based on a control signal received from the second mobile terminal 200 instead of the first mobile terminal 100.

At this time, when the controller 1180 of the UAV 1000 may control the wing part 1210 so that flight is maintained at a point where the UAV is located at the time of transmitting the control request signal until the control approval signal is received. Here, maintaining flight of the UAV 1000 at one point may be referred to as hovering or a hovering mode (function, operation).

Specifically, when it is detected that the UAV enters a preset state in which it is impossible to control the UAV by the first mobile terminal 100, from a state that the UAV 1000 is connected to the first mobile terminal through wireless communication, the controller 1180 of the UAV 1000 may transmit the control request signal to the second mobile terminal 200. Here, the detection point and the point at which the control request signal is transmitted may be the same or may have a predetermined time difference.

When the control request signal is transmitted (or when it is detected that the UAV enters the preset state in which it is impossible to control the UAV), the controller 1180 may maintain flight at the flight point (position) at the transmission time (or detection time). The flight at the corresponding point may be maintained until a control approval signal is received.

Thereafter, in the present invention, referring to FIG. 3, a step of transmitting notification information indicating that the control terminal has been changed is performed (S450). For example, when the control approval signal from the second mobile terminal 200 is received, the controller 1180 of the UAV 1000 may transmit notification information indicating that the mobile terminal capable of controlling the UAV 1000 has been changed to at least one of mobile terminal(s) corresponding to at least one terminal Information transmitted from the first mobile terminal (e.g., at least one of the first mobile terminal and the second mobile terminal).

For example, as illustrated in (a) of FIG. 5B, when a control request signal is transmitted from the UAV 1000 to the second mobile terminal 200, notification information 500a indicating whether the control request signal is approved or not may be displayed on the display unit 151 of the second mobile terminal 200. Thereafter, when an approval (accept) command for the control request signal is applied, the second mobile terminal 200 may transmit a control approval signal for the control request signal to the UAV 1000 and may be connected with the UAV 1000 to perform wireless communication.

Specifically, when the control request signal is received from the UAV 1000, the controller 180 of the second mobile terminal 200 may display screen information 500a corresponding to the control request signal on the display unit 151. Also, the controller 180 of the second mobile terminal 200 may control the communication unit to transmit the control approval signal for the control request signal to the UAV based on a user request.

When the control approval signal is transmitted, the communication unit may be connected to perform wireless communication with the UAV. In addition, screen information received from the UAV 1000 may be displayed on the display unit 151.

As illustrated in (b) of FIG. 5B, when the second mobile terminal 200 and the UAV 1000 are connected to each other so as to perform wireless communication, notification information 500b indicating that the mobile terminal capable of controlling the UAV 1000 has been changed, on the display unit 151 of the second mobile terminal (or the first mobile terminal).

When the UAV is connected to the second mobile terminal 200 different from the first mobile terminal 100 to perform wireless communication, the controller 1180 of the UAV 1000 may transmit a preview image 510 received through the camera 1121 of the UAV 1000 and at least one image 520 captured through the camera 1121 to the second mobile terminal 200.

In this case, the preview image 510 and the at least one image 520 received from the UAV 1000 may foe displayed on the display unit 151 of the second mobile terminal 200. The at least one image 520 may be an image captured in a state of being connected to the first mobile terminal 100 to perform wireless communication. The at least one image 520 may be displayed on or disappear from the display unit 151 based on applying of a predetermined type of touch (e.g., long touch, multi-touch, drag touch, double touch, etc.).

In the present invention, the UAV 1000 transmits an image (at least one image) captured in a state of being connected to the first mobile terminal 100 to perform wireless communication to the second mobile terminal 200, so that the user of the second mobile terminal 200 may easily recognize the captured image.

As described above, in the present invention, in a state that a control right for controlling the UAV is set in the first mobile terminal, when the first mobile terminal enters an uncontrollable state, a control method for setting a control right to the second mobile terminal different from the first mobile terminal in an optimized manner may be provided.

On the other hand, in the present invention, in addition to that the UAV 1000 enters the preset state (for example, the connected signal strength becomes weaker than the reference strength or a preset control signal related to the control is received from the mobile terminal), the mobile terminal capable of controlling the UAV 1000 may be changed (i.e., the control right may be changed to another terminal).

FIGS. 6A, 6B, and 6C are conceptual diagrams illustrating a method for changing a mobile terminal that controls an UAV based on a user request, according to an embodiment of the present invention.

In a state that the first mobile terminal 100 and the UAV 1000 are connected to each other so that they may communicate wirelessly, a preview image received from the UAV 1000 and at least one terminal information capable of controlling the UAV 1000 may be displayed on the display unit 151 of the first mobile terminal 100 as illustrated in (a) of FIG. 6A.

When any one of the at least one terminal information is selected, the controller 180 of the first mobile terminal 100 may transmit the selected terminal information to the UAV 1000 so that the UAV may transmit a control request signal corresponding to the selected terminal information to the mobile terminal corresponding to the selected terminal information.

For example, as shown in (a) of FIG. 6A, an icon 612 associated with a function of changing the mobile terminal capable of controlling the UAV 1000 may be displayed on the display unit 151 (or near the at least one terminal Information). Each terminal information may be associated with the icon 612.

The icon 612 may be output to the display unit 151 based on selection of a graphic object 610 associated with an output function of the icon 612.

When any one icon 612a among the icons 612 is selected, the controller 180 of the first mobile terminal 100 may transmit the terminal information associated with the any one of the icon 612a to the UAV 1000.

The UAV 1000 may transmit a control request signal to the mobile terminal corresponding to the terminal information based on the terminal Information received from the first mobile terminal 100. For example, when the selected terminal information is the second mobile terminal information 200a, the controller 1180 of the UAV 1000 may transmit a control request signal to the second mobile terminal 200 corresponding to the second mobile terminal information 200a.

Screen information corresponding to the control request signal may be displayed on the display unit 151 of the second mobile terminal 200. Thereafter, when a control approval signal for the control request signal is received from the second mobile terminal 200, the UAV 1000 may be connected to perform wireless communication with the second mobile terminal 200. That is, the mobile terminal capable of controlling the UAV 1000 may be changed from the first mobile terminal 100 to the second mobile terminal 200.

At this time, when the UAV 1000 is connected to perform wireless communication with the mobile terminal (second mobile terminal) corresponding to the selected terminal information, the controller 1180 of the UAV 1000 may transmit notification information indicating that the mobile terminal capable of controlling the UAV 1000 has been changed, to a mobile terminal (for example, first to third mobile terminals) corresponding to at least one terminal information transmitted from the first mobile terminal 100.

Also, as shown in (c) of FIG. 6A, display order of at least one terminal information may be changed on the display unit 151 of the first mobile terminal 100 or an indicator indicating the mobile terminal that controls the UAV 1000 may be displayed in the vicinity of the second mobile terminal information.

Meanwhile, as the first mobile terminal 100 is first connected to the UAV 1000, the first mobile terminal 100 may be set as a master terminal. In this state, when the second mobile terminal information is received from the first mobile terminal 100, the communication unit of the UAV 1000 may transmit a control request signal to the second mobile terminal.

When the control approval signal is received from the second mobile terminal 200, the communication unit of the UAV 1000 may be connected to perform wireless communication with the second mobile terminal 200.

At this time, in a state that the UAV 1000 is connected to perform wireless communication with the second mobile terminal 200, when a control right request signal is received from the first mobile terminal 100, the controller 1180 of the UAV 1000 may release the connection to the second mobile terminal 200 and control the communication unit of the UAV so that the UAV may be connected to the first mobile terminal 100. That is, when the control right request signal is received from the first mobile terminal 100, the controller 1180 of the UAV may change the mobile terminal capable of controlling the UAV from the second mobile terminal 200 to the first mobile terminal 100.

In this case, when the control right request signal is received from the third mobile terminal 300 different from the first mobile terminal 100, the connection with the second mobile terminal 100 may be released based on an approval signal received from the second mobile terminal. On the other hand, the connection with the second mobile terminal may be released without the approval signal when the control right request signal is received from the first mobile terminal 100.

For example, when the second mobile terminal 200 (slave terminal) and the UAV 100 are connected to each other, the icon 620 associated with a function of requesting (withdrawing) a control right may be displayed on the display unit 151 of the first mobile terminal 100 (master terminal).

When the icon 820 is selected, the controller 180 of the first mobile terminal 100 may transmit a control right request (withdrawal) signal to the UAV 1000. In this case, based on the transmission of the control right request (withdrawal) signal from the first mobile terminal 100 as a master terminal, the controller 180 of the UAV 1000 may release the connection with the second mobile terminal 200 and may be connected to the first mobile terminal 100 (that is, the control right may be changed from the second mobile terminal to the first mobile terminal) although an approval signal of the second mobile terminal is not received.

In this case, as shown in (b) of FIG. 6B, notification information indicating that the mobile terminal controlling the UAV has been changed (indicating that the control right has been changed) may be displayed on the display unit 151 of the second mobile terminal 200.

Meanwhile, in a state that the second mobile terminal 200 (slave terminal) and the UAV 100 are connected, a control right request signal from the third mobile terminal 300 (another slave terminal) is received to the UAV 1000. In this case, the controller 1180 of the UAV 1000 may transmit to the second mobile terminal 200 information indicating that the control right request signal has been received from the third mobile terminal 300. When an approval signal for the control right request signal is received from the second mobile terminal 200, the controller 180 of the UAV 1000 may release the connection with the second mobile terminal 200 and may be connected for wireless communication with the third mobile terminal 300.

Meanwhile, if the approval signal for the control right request signal is not received, the connection between the UAV 1000 and the second mobile terminal 200 may be maintained.

Meanwhile, in the present invention, the master terminal may be changed. For example, as shown in (a) of FIG. 6C, a graphic object 630 associated with a function of setting a master terminal may be displayed on the display unit 151 of the first mobile terminal 100. When the graphic object 630 is selected, an icon 632 for selecting at least one terminal information capable of controlling the UAV 1000 may be displayed on the display unit 151 as shown in (b) of FIG. 6C. If any one icon 632a is selected, the controller 180 of the first mobile terminal 100 may transmit a signal for changing the master terminal to the UAV 1000. The signal may include the selected terminal information.

As shown in (c) of FIG. 6C, the controller 1180 of the UAV 1000 may transmit a signal asking whether to accept a change in the master terminal to the mobile terminal corresponding to the selected terminal information (for example, the second mobile terminal 200). When an accept signal is received from the second mobile terminal 200, the UAV 1000 may change the master terminal from the first mobile terminal 100 to the second mobile terminal 200. In this case, the second mobile terminal 200 may be connected to perform wireless communication with the UAV 1000 (that is, the control right may also be changed from the first mobile terminal to the second mobile terminal).

Through this configuration, the present invention may provide an optimized UI/UX that may change the mobile terminal that controls the UAV more conveniently.

Hereinafter, a method for landing a UAV related to the present invention will be described in more detail with reference to the accompanying drawings.

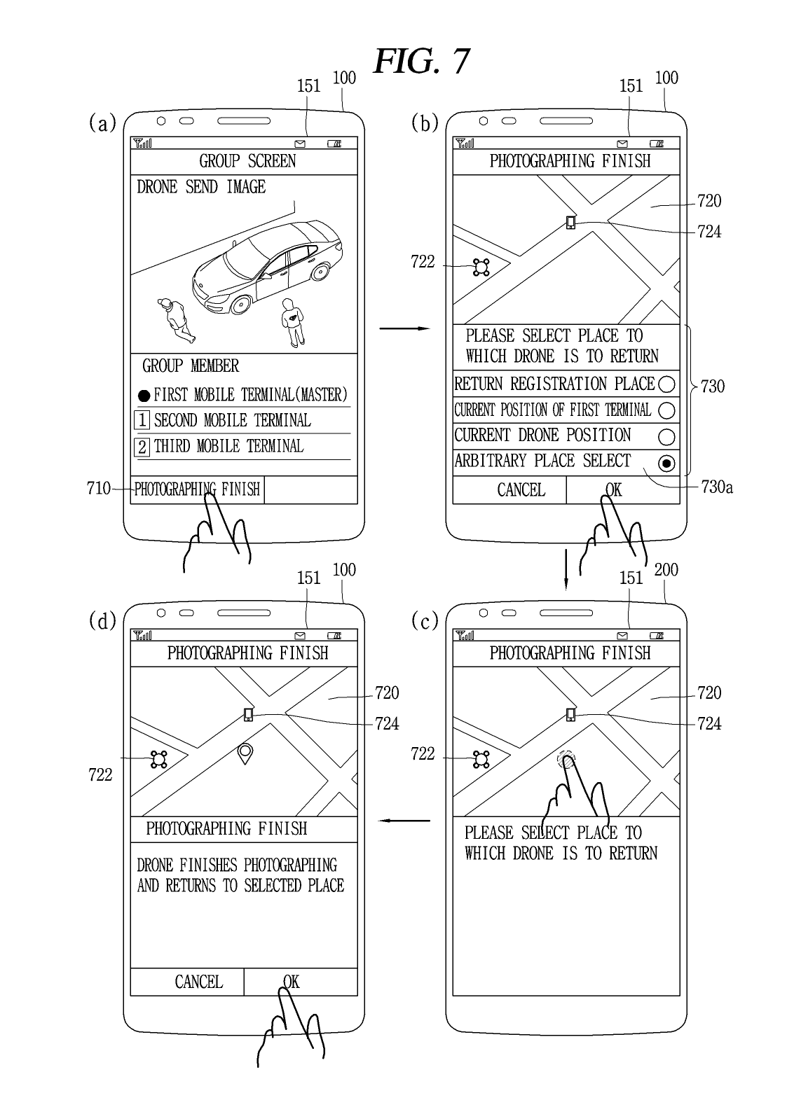

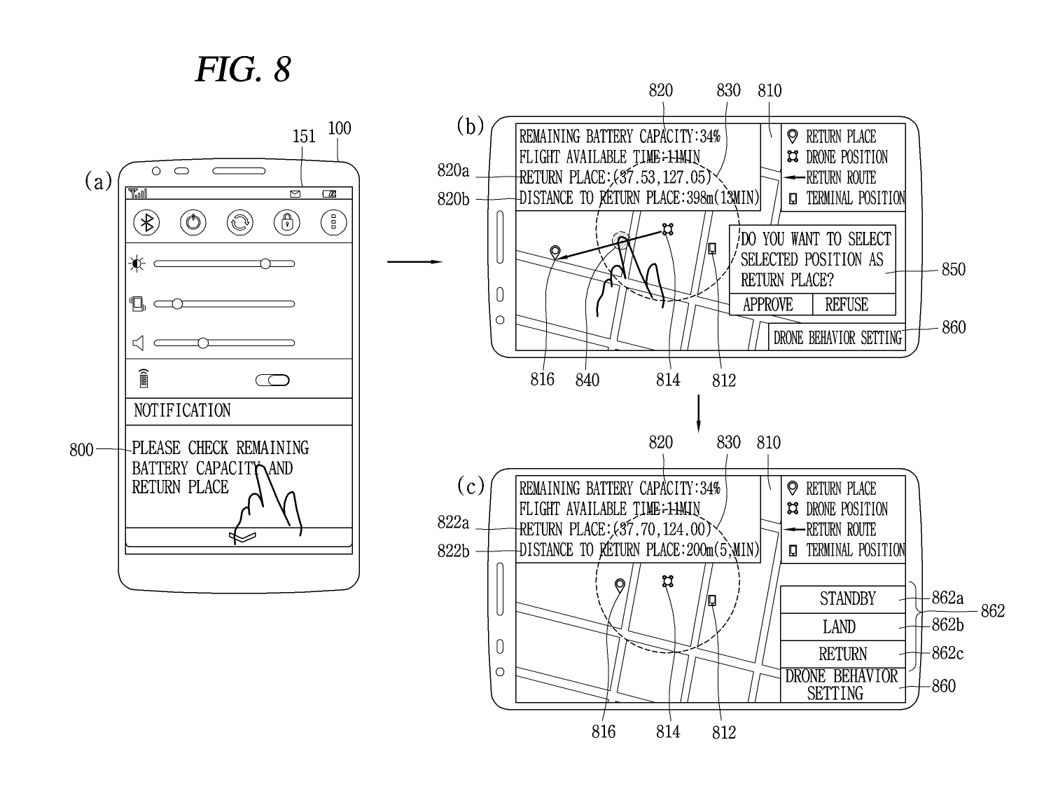

FIGS. 7 and 8 are conceptual diagrams for illustrating a control method for controlling a UAV of the present invention to land.

As illustrated in (a) of FIG. 7, an icon 710 associated with a function of stopping photographing of the UAV 1000 or a function of landing the UAV 1000 may be output on the display unit 151 of the mobile terminal 100. The Icon 710 may be output on the display unit 151 based on a user request.

When the icon 710 is selected, the controller 180 may be output map information 720 and a menu (or graphic object) 730 for selecting landing position information, to the display unit 151.

The map information 720 may include a graphic object 722 indicating a position of the UAV and a graphic object 724 indicating a position of the mobile terminal 100.

Also, the menu 730 may include preset landing position information, current position information of the mobile terminal 100, current position information of the UAV 1000, and the like, and may further include an item 730a for selecting position information by the user.

After the item 730a is selected, when a touch is applied to one point 740 of the map information displayed on the display unit 151 as shown in (c) of FIG. 7, the controller 180 may set position information corresponding to the one point 740 as a landing point of the UAV 1000 as shown in (d) of FIG. 7.

Meanwhile, as illustrated in (a) of FIG. 8, the controller 1180 of the unmanned airplane 1000 may transmit notification information 800 to the mobile terminal 100 based on a battery amount of a power supply unit of the UAV 1000.

More specifically, the controller 1180 of the UAV 1000 may transmit the notification information 800 to the mobile terminal 100 based on a case where a flight available distance according to an amount of the battery is shorter than a distance between the current UAV and a preset landing position information or a case where the flight available distance is shorter than a distance between the current UAV and the current mobile terminal.

When the notification information 800 is selected, map information 810, information 820 relating to the UAV, an icon 814 indicating a position of the UAV 1000, an icon 812 indicating a current position of the mobile terminal, and an icon 816 indicating preset landing position information may be displayed on the display unit 151 of the mobile terminal 100. Also, an indicator 830 for guiding a flight available range (or maximum range) of the UAV 1000 with respect to a current battery amount may foe displayed on the display unit 151. Also, an icon 860 capable of selecting an operation of the UAV 1000 may be displayed on the display unit 151.

The information 820b related to the UAV may include a distance (time) from the preset landing position information 820a and information 820b on a distance (time) from a current position of the UAV 1000 to a position corresponding to the landing position information.

In this state, when a touch is applied to one point in the indicator 830, the controller 180 may output a notification window 850 for guiding whether to change a landing position of the UAV to a position corresponding to the one point.

If the change for the landing position is accepted, the controller 180 may change a landing position of the UAV 1000 to a position corresponding to the one point and display an icon 816 for guiding the changed position at the one point, as shown in (c) of FIG. 8. In this case, the information 820 related to the UAV is displayed as position information 822a for the changed position and the information 822b about the distance (time) from the current position of the UAV 1000 to the changed position. The controller 180 may transmit position information on the changed position to the UAV 1000.

Meanwhile, when the icon 860 is selected, a menu 862 associated with an operation of the UAV 1000 may be output on the display unit 151.

The menu 862 may include an item 862a associated with an operation of maintaining (hovering) flight at a point where the UAV 1000 is currently positioned, an item 862b associated with an operation of landing the UAV 1000 at a point where the UAV 1000 is currently located, and an item 862c associated with an operation of landing the UAV to a position corresponding to the landing position information, and the like.

After the landing position is changed, if the item 862c associated with the operation of landing to the position corresponding to the landing position information is selected among the stems, the controller 180 may transmit a control signal for landing to the changed position, to the UAV 1000.

Through the configuration, the present invention may provide a control method capable of landing the UAV in a more optimized manner.

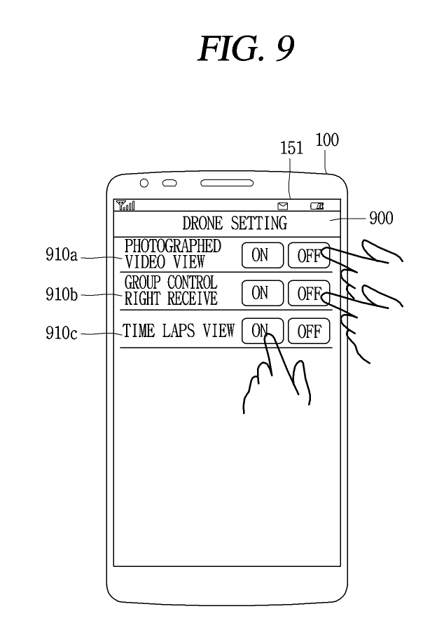

FIG. 9 is a conceptual diagram for illustrating a user interface related to control of the UAV according to an embodiment of the present invention.

A setting screen 900 for setting a specific function of an application related to control of the UAV 1000 may be displayed on the display unit 151 in the mobile terminal 100 according to the present invention. The setting screen 900 may be output based on a user request.

Also, the setting screen 900 may include an item 910a for selecting whether to output a preview image received from the UAV 1000, an item 910a for selecting whether to receive a control request signal from the UAV 1000, and an item 910c for selecting whether to receive at least one image captured while the UAV 1000 is being controlled by another mobile terminal in case where the UAV was controlled by the other mobile terminal and is currently controlled by the mobile terminal 100 (or in case where the mobile terminal controlling the UAV is changed from the other mobile terminal to the present mobile terminal).

As described above, the present invention may provide an optimized control method for controlling the UAV using the second mobile terminal different from the first mobile terminal, when a connection signal strength between the first mobile terminal controlling the UAV and the UAV becomes weak or when the first mobile terminal enters a state in which it is impossible to control the UAV.

Further, the present invention may provide a control method for selecting the second mobile terminal capable of controlling the UAV more stably by selecting the second mobile terminal based on not only the priority set by the user but also an image captured by the UAV, when the second mobile terminal different from the first mobile terminal is selected.

In addition, in the present invention, when the mobile terminal capable of controlling the UAV is changed from the first mobile terminal to the second mobile terminal, an image captured by the control of the first mobile terminal may be checked in the second mobile terminal. Accordingly, the user may more easily and simply recognize a previously photographed region and a region to be photographed in the future.

In addition, the present invention may provide a UI/UX capable of more simply changing a mobile terminal capable of controlling the UAV according to a user's request.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal. As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore ail changes and modifications that fall within the metes and bounds of the claims, or equivalents of such metes and bounds are therefore intended to be embraced by the appended claims.

1. An unmanned aerial vehicle (UAV) comprising:
a communication unit performing wireless communication with a first mobile terminal; and
a controller performing a function corresponding to a control signal received from the first mobile terminal,
wherein in a state that the UAV is connected to the first mobile terminal to perform wireless communication, the controller transmits a control request signal to a second mobile terminal different from the first mobile terminal on the basis of at least one of connected signal strength and receiving of a preset control signal.

2. The UAV of claim 1, wherein the controller receives at least one terminal information from the first mobile terminal, and the second mobile terminal is determined based on the at least one terminal information.

3. The UAV of claim 2, wherein priority is set in the at least one terminal information, and the controller transmits the control request signal based on the priority.

4. The UAV of claim 1, further comprising:
a camera,
wherein the controller recognizes an image related to a face included in an image received through the camera, and determines the second mobile terminal based on terminal information associated with the recognized image.

5. The UAV of claim 4, wherein the controller receives at least one terminal information from the first mobile terminal, and when priority related to the second mobile terminal is set in the at least one terminal information, the controller determines the second mobile terminal based on the recognized image and the priority.

6. The UAV of claim 5, wherein when terminal information associated with the recognized image and terminal information determined based on the priority are different, the priority is changed based on the terminal information associated with the recognized image.

7. The UAV of claim 4, wherein when the determined second mobile terminal is connected to perform wireless communication, the controller transmits at least one image captured through the camera to the second mobile terminal.

8. The UAV of claim 1, wherein when a control approval signal for the control request signal is received from the second mobile terminal, the controller performs a function corresponding to a control signal received from the second mobile terminal instead of the first mobile terminal.

9. The UAV of claim 8, further comprising:
a wing part;
wherein when the control request signal is transmitted, the controller controls the wing part to maintain flight at a point where the UAV is positioned at the time of transmitting the control request signal, until the control approval signal is received.

10. The UAV of claim 8, wherein when the control approval signal is received, the controller transmits notification information indicating that a mobile terminal capable of controlling the UAV has been changed to at least one of the first and second mobile terminals.

11. The UAV of claim 8, wherein when the control approval signal is received, the communication unit connects the UAV to perform wireless communication with the second mobile terminal, and when a control right request signal is received from the first mobile terminal in a state that the UAV is connected to perform wireless communication with the second mobile terminal, the controller releases the connection to the second mobile terminal and control the communication unit to connect the UAV to the first mobile terminal.

12. The UAV of claim 11, wherein the connection to the second mobile terminal is released based on an approval signal received from the second mobile terminal when a control right request signal is received from a third mobile terminal different from the first mobile terminal, and when a control right request signal is received from the first mobile terminal, the connection to the second mobile terminal is released without the approval signal.

13. A mobile terminal comprising:
a communication unit performing wireless communication with an unmanned aerial vehicle (UAV); and
a controller generating at least one terminal information capable of controlling the UAV based on a user request and controlling the communication unit to transmit the generated terminal information to the UAV.

14. The mobile terminal of claim 13, further comprising:
a sensing unit sensing movement of the mobile terminal,
wherein when a preset movement is sensed through the sensing unit in a state that the mobile terminal is connected to the UAV to perform wireless communication, the controller transmits a preset control signal related to control to the UAV.

15. The mobile terminal of claim 14, wherein the preset movement is a movement that the mobile terminal moves by a predetermined distance or greater within a reference time, and the preset control signal related to control is a signal indicating that it is impossible to control the UAV.

16. A mobile terminal comprising:
a communication unit performing wireless communication with an unmanned aerial vehicle (UAV);
a display unit; and
a controller displaying screen information corresponding to a control request signal when the control request signal is received from the UAV, and controlling the communication unit to transmit a control approval signal for the control request signal to the UAV based on a user request,
wherein the communication unit is connected with the UAV to perform wireless communication when the control approval signal is transmitted, and screen information received from the UAV is displayed on the display unit.

17. The mobile terminal of claim 16, wherein a preview image received through a camera provided in the UAV and at least one image previously captured through the camera are displayed on the display unit.

18. The mobile terminal of claim 16, wherein information of at least one terminal capable of controlling the UAV is displayed on the display unit, and when any one of the terminal information is selected, the controller transmits the selected terminal information to the UAV so that the UAV transmits a control request signal to a mobile terminal corresponding to the selected terminal information.

19. The mobile terminal of claim 18, wherein when the mobile terminal corresponding to the selected terminal information and the UAV are connected to perform wireless communication, notification information indicating that the mobile terminal capable of controlling the UAV has been changed is displayed on the display unit.

20. A method for controlling an unmanned aerial vehicle (UAV), the method comprising:
connecting the UAV to perform wireless communication with a first mobile terminal; and
transmitting a control request signal to a second mobile terminal different from the first mobile terminal based on at least one of the connected signal strength and receiving a preset control signal in a state that the UAV is connected to perform wireless communication with the first mobile terminal.
